(19) United States
(12) Patent Application Publication
(10) Pub. No.: US 2011/0122752 A1
(43) Pub. Date: May 26, 2011

(54) COPY PROTECTION SYSTEM FOR OPTICAL DISCS

(76) Inventors: Anthony Miles, Glamorgan (GB); Iain Benson, Glamorgan (GB)

(21) Appl. No.: 12/867,610

(22) PCT Filed: Feb. 12, 2009
(86) PCT No.: PCT/GB2009/000387

§ 371 Date: Feb. 7, 2011

(30) Foreign Application Priority Data
Feb. 14, 2008 (GB) 0802752.6
Mar. 3, 2008 (GB) 0803946.3

(51) Int. Cl. G11B 20/00

(52) U.S. Cl. 369/53.21; G9B/20.002

(57) ABSTRACT

An optical disc has a recording format including a first index indicating the positions of each of a plurality of program blocks within a program area, the program blocks comprising one or more content blocks containing readable data, and one or more unrecoverable blocks containing unrecoverable data, the recording format including a second index indicating the positions of the content blocks without indicating the positions of the unrecoverable blocks. Preferably, the second index indicates preferred start points for playing content on the optical disc.

### FIELD OF THE INVENTION

This invention concerns methods, software and formats for preventing or restricting copying of data, particularly as recorded in digital form on a carrier such as optical disc media. In this description, the term ‘optical disc media’ is intended to include discs conforming substantially to the DVD, HD-DVD and Blu-ray (BD) standards, as well as similar media that may be read using electromagnetic radiation either within or outside the visible range.

### BACKGROUND OF THE INVENTION

The DVD format is currently the preferred format for the distribution of high-quality video content, and includes various measures designed to restrict the copying of content. These include Content Scrambling System (CSS) encryption, which requires player software to know the relevant encryption keys in order to play back the content.

DVDs may be played by dedicated players, which generally contain a player program in firmware and are not reprogrammable. The player program includes the encryption keys required to play the content of the DVD, but is not configurable to copy the content. DVDs may also be played on DVD drives as peripherals of general purpose computers, which run a player program such as WinDVD® or PowerDVD® in order to decrypt and play the content. However, the CSS and other measures have been circumvented, resulting in the availability of various programs that make it technically straightforward to copy content from DVD's using a general-purpose computer. Hence, the copyright owners are left only with legal means of redress against unauthorised copying of content.

Various technical means of copy protecting DVDs are known in the art. For example, EP-A-1566 803 discloses a format in which unreadable or subversive data is introduced to prevent or hinder ripping by sequential copying of sectors, and pointers to prevent the subversive data being accessed during normal playback. There are no navigable paths to the subversive data.

The applicant's patent publication WO-A-03/077246 discloses a format for copy protection of optical discs, such as compact discs, in which the table of contents indicates a dummy start position of a track, with unrecoverable data being present at the dummy start position, while a subchannel indicates the true start position of the track. Players that take into account the subchannel information as well as the table of contents are thereby permitted to read the track.

The applicant's patent publication WO-A-04/109681 discloses a further development, in which an additional index is included to allow some types of player to determine the true start position of the tracks. The additional index may be a Video CD index.

### STATEMENT OF THE INVENTION

According to one aspect of the present invention, there is provided an optical disc having a recording format including a first index indicating the positions of each of a plurality of program blocks within a program area, the program blocks comprising one or more content blocks containing readable data, and one or more unrecoverable blocks containing unrecoverable data, the recording format including a second index indicating the positions of the content blocks without indicating the positions of the unrecoverable blocks. Preferably, the second index indicates preferred start points or navigation pointers for playing content on the optical disc.

In this way, an optical disc player is enabled to play the content blocks and avoid reading the unrecoverable blocks, while a serial copying program will attempt to read both the content blocks and the unrecoverable blocks, thereby encountering an error condition that prevents copying the content blocks.

According to another aspect of the invention, there is provided a method of circumventing the recording format of the first aspect, by selectively reading and thereby copying only the content blocks and not the unrecoverable blocks, by means of the second index.

According to another aspect of the invention, there is provided an optical disc having a first navigational pointer within the program area that points to a second navigational pointer outside the program area.

According to another aspect of the invention, there is provided a method of authenticating an optical disc by detecting the presence of authentication information within an unrecoverable block of the disc. The block may be an initial and/or final block.

According to another aspect of the invention, there is provided a method of authenticating an optical disc by referring to a database of original discs that include copy protection, determining whether the content of a disc corresponds to that of an original disc within the database, and if so, determining the disc as authentic if the copy protection is present.

The present invention extends to a method of recording an optical disc, a computer program for performing the method, and the data structure of the optical disc.

### BRIEF DESCRIPTION OF THE DRAWINGS

A detailed description of the preferred embodiments will now be described with reference to the accompanying drawings, in which:

FIG. 1 is a diagram of a DVD disc format comprising a single track, in a first embodiment of the invention;

FIG. 2 is a diagram of a DVD disc format comprising a single track, in a second embodiment of the invention; and

FIG. 3 is diagram illustrating the stages of manufacture of an optical disc according to the first or second embodiment.

### DESCRIPTION OF THE EMBODIMENTS

### Background

The following aspects of the standard DVD format are described to aid understanding the background to embodiments of the present invention. The skilled person will be aware of further details of the DVD format, which will therefore not be described.

The data on a DVD is recorded on a spiral track on the optical disc. The data comprises a lead-in area, a data area, and a lead-out area. The data area includes a volume descriptor which identifies the structure and contents of the data area, together with one or more tracks. Each track includes an IFO (information) file, containing navigation information for individual title sets within the track. Each title set may comprise audio, video and/or data content, together with control data for determining how the content is presented.

The optical disc includes UDF file system data, which allows the content of the disc to be identified using the UDF standard for optical discs. The disc may also include ISO 9660 file system data, describing the same file system as the UDF data, for compatibility with the ISO 9660 standard.

In the following description, a dedicated DVD player of the type described above will be referred to as a ‘DVD player’, while a DVD drive connected as a peripheral to a general purpose computer will be referred to a ‘DVD drive’.

### Specific Embodiments of the Invention

An embodiment of the invention comprises an optical disc that complies with the DVD standard, except as described below. In this embodiment, the data content of the disc comprises a single track, which may occupy one or more layers of the optical disc.

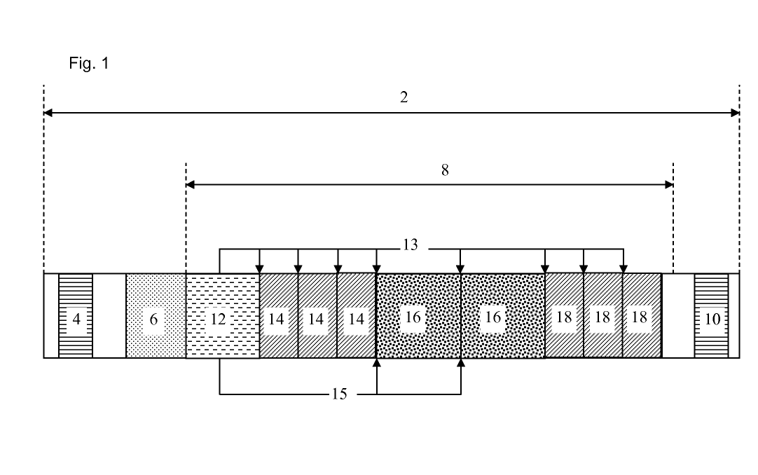

The format of the optical disc is as shown in FIG. 1. The single track 2 comprises, in sequential order, a start encapsulation block 4 containing unrecoverable data, an ISO/UDF file system block 6, a file system program area 8 and an end encapsulation block 10 containing unrecoverable data.

The file system program area 8 comprises, in sequential order, a navigational data block 12 (i.e. an IFO file), at least one initial encapsulation blocks 14, at least one title set blocks 16, and at least one final encapsulation blocks 18. Note that it is not essential for both the initial and final encapsulation blocks 14, 18 to be present, and embodiments may include only one or more initial encapsulation blocks 14 or one or more final encapsulation blocks 18. There may be a large number of initial and/or final encapsulation blocks 14, 18, preferably significantly greater in number than the title set blocks 16. The initial and/or final encapsulation blocks 14, 18 contain unrecoverable data.

The unrecoverable data contained within the encapsulation blocks 4, 10, 14, 18 contains control data that complies with the DVD standard, but the data itself is recorded in a format that cannot be read correctly by a DVD player.

The navigational data block 12 includes respective pointers 13 to the initial encapsulation block(s) 14, the title set block(s) 16 and the final encapsulation block(s) 18. The navigational data block 12 also includes preferred playback pointers 15, which indicate the positions of the title set blocks 16 but not the positions of the initial or final encapsulation blocks 14, 18. The preferred playback pointers 15 are in accordance with the DVD standard, in which they are referred to as navigation pointers; their function is conventionally to indicate to DVD players where playback should preferably commence.

The file system block 6 includes a pointer to the start of the file system program area 8, and hence to the start of the navigational data block 12, but does not include pointers to the initial or final encapsulation blocks 12, 18 or to the title set blocks 16, since this internal structure does not form part of the UDF/ISO standard.

When the disc is loaded into a DVD player, the player reads the file system block 6 and ignores the encapsulation start and end blocks 4 and 10. When instructed to play the DVD, the player reads the navigational data block 12 and determines, from the preferred playback pointers 15, at which point to commence playing. In this way, the DVD player plays the title set blocks and does not attempt to play the initial and/or final encapsulation blocks 14, 16.

If an attempt is made to copy the disc on a general-purpose computer, the disc is loaded into a DVD drive and a ‘ripper’ program is run on the computer. Ripper programs generally attempt to make an exact copy of the data recorded on the disc, and in that case the ripper program will attempt to read the unrecoverable data in the encapsulation start block 4 and/or the encapsulation end block 10; as a result, the DVD drive will signal an error condition to the ripper program, and the ripping operation will fail.

More sophisticated ripper programs may ignore the encapsulation start and/or end blocks 4, 10 and read only the file system block 6 outside the file system program area 8. The ripper program then reads the navigational data block 12 to determine the positions of title set blocks, in this case the initial and/or final encapsulation blocks 14, 18 and the title set blocks 16. The ripper program ignores the preferred playback pointers 15, since these are apparently not relevant to copying. Hence, the initial and/or final encapsulation blocks 14, 18 are indistinguishable from the title set blocks 16 to the ripper program, which attempts to read and therefore copy each of these blocks in turn. However, reading the unrecoverable data in the initial and/or final encapsulation blocks 14, 18 causes the DVD drive to signal an error condition to the ripper program, such that the ripping operation will fail.

In this way, the DVD format prevents ripping of the contents, but allows the contents to be played by a DVD player.

Circumvention Techniques

In an attempt to circumvent the above described copy protection format, it is envisaged that a ripper program may be designed to read the preferred playback pointers 15 within the navigational data 12, and to copy only the title set blocks 16 indicated by the preferred playback pointers 15 and to avoid reading the initial and/or final encapsulation blocks 14, 18. For example, the ripper program might then produce a copied DVD in which the initial and/or final encapsulation blocks 14, 18 are reproduced as blank title sets. Such a ripper program is based on knowledge of the principles of the present invention and is therefore considered an embodiment of another aspect of the present invention.

Anti-Circumvention Features

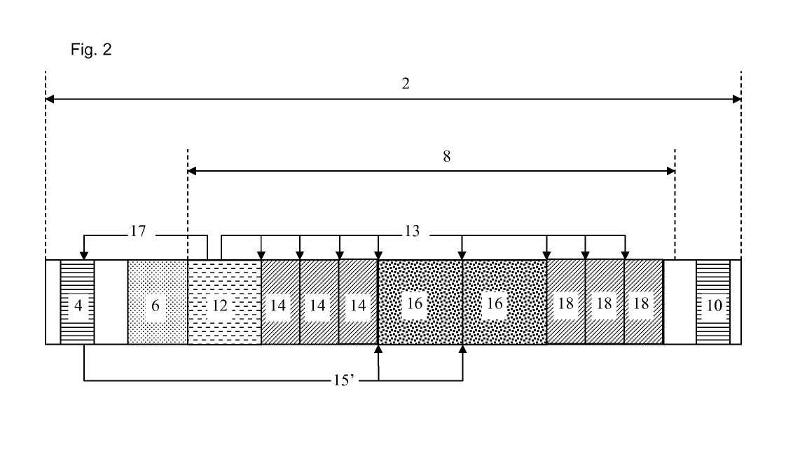

A second embodiment, which aims to defeat the circumvention technique described above, will now be described with reference to FIG. 2. The initial and/or final encapsulation blocks 14, 18 include one or more encapsulated navigational pointers 15′. In this case, the encapsulated navigational pointers 15′ indicate the preferred playback positions as indicated by the pointers 15 of the first embodiment, but they may alternatively or additionally replace the pointers 13 of the first embodiment. In other words, the direct pointers 13, 15 of the first embodiment may be replaced by indirect pointers via the initial and/or final encapsulation blocks 14, 18 in the second embodiment.

The location(s) of the navigational pointer(s) may be indicated by one or more pointers 17 within the file system program area 8, for example in the navigational block 12. Hence, the navigational pointers 17 and 15′ form a pointer chain via the initial and/or final encapsulation blocks 14, 18. If the content of initial and/or final encapsulation blocks 14, 18 is removed by the ripper program when creating a copied disc, the pointer chain is broken and it is not possible to navigate correctly within the copied disc.

Preferably, the encapsulated navigational pointers 15′ are located within the unrecoverable data so as not to be easily separable from the unrecoverable data if the blocks are read sequentially; in this way, a ripper program is prevented from copying the navigational pointers 15′ without the unrecoverable data.

Disc Authentication

As an additional or alternative feature, the initial and/or final encapsulation blocks 14, 18 may include authentication information that identifies the disc as authentic. The authentication information may form part of the unrecoverable data, or may be separate from the unrecoverable data. The authentication information may be formed as a ‘watermark’ such that it is not easily separable from other data within the initial and/or final encapsulation blocks 14, 18.

If a ripper program avoids copying the initial and/or final encapsulation blocks 14, 18 in a copied disc, then the authentication information will be lost. The presence of the authentication information in the initial and/or final encapsulation blocks 14, 18 may therefore be used as an indication that a disc is genuine. In an embodiment in which the authentication information forms part of the unrecoverable data, the unrecoverable data may be read and the authentication information identified by a dedicated player program loaded on computer connected to an optical disc drive, or by a modified disc player; in either case, playback of the disc may be inhibited if the authentication information is missing or does not correspond to the content of the disc. A database of authentication information corresponding to different original discs may be created, and the detected authentication information may be checked against the content of disc in the database to determine whether the authentication information is correct. The content may be indicated in the database as a hash value, similar to that currently used in the CDDB database.

Alternatively, the database may identify the content a set of original discs which were protected by unrecoverable data in the initial and/or final encapsulation blocks 14, 18. If the content of a disc matches an entry on the database but the initial and/or final encapsulation blocks 14, 18 do not contain unrecoverable data, the disc is determined not to be authentic.

Disc Production

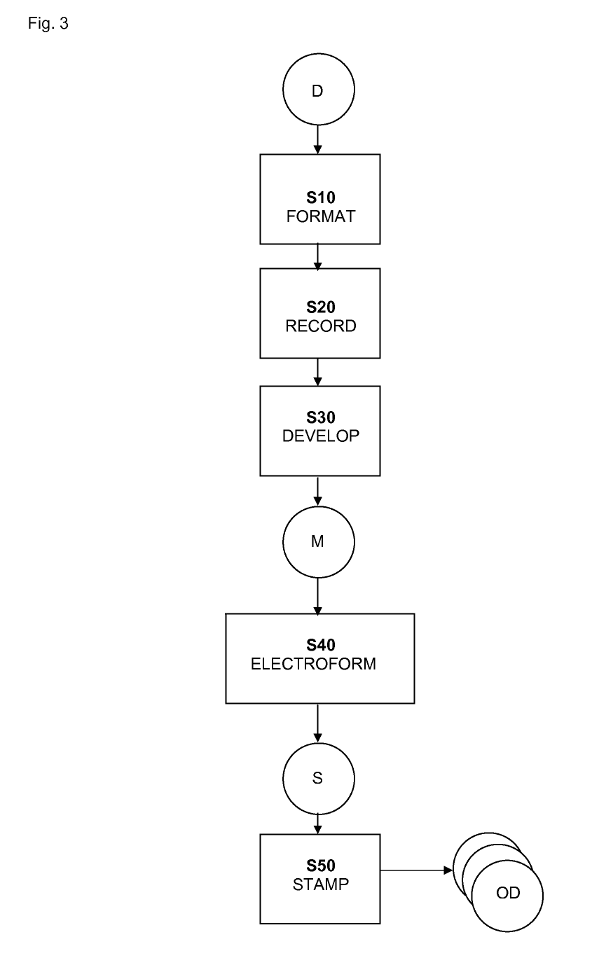

To produce an optical disc formatted according to an embodiment of the invention requires special software to be used during the mastering process, which is illustrated in FIG. 3. The source data D for one or more tracks is provided on a carrier, which may itself be a recordable optical disc or a digital tape. The source data is formatted (S10) by software to generate a session and associated data in the format described above, for recording on the optical disc. The formatted data is recorded (S20) on an optical disc master, using for example a laser beam recorder which writes the data on a coated glass master. The glass master is developed (S30) to produce a metallized glass master M. The master may be used to produce one or more stampers S by an electroforming process (S40). Optical discs OD are mass-produced from the stamper S by a stamping process (S50). In an alternative embodiment suitable for low volume production, recordable optical discs may be recorded directly with the formatted data.

The formatted data may be recorded as a data set for input to the recorder at a subsequent time.

Embodiments of the invention include disc production software for formatting data and/or controlling a recording process to generate one or more discs having a format in accordance with an embodiment of the invention. Embodiments also include formatted data having a structure as defined above.

The above embodiments are provided purely by way of example. Alternatives, which may be apparent to the skilled person on reading the specification, may nevertheless fall within the invention as defined by the claims.

1. An optical disc having content data recorded thereon, in a format comprising:
a. a plurality of program blocks within a program area on the disc, the program blocks comprising one or more content blocks comprising the content data, and one or more copy protection blocks containing unreadable data,
b. a first index indicating the positions of each of the plurality of program blocks; and
c. a second index indicating the positions of the content blocks without indicating the positions of the unreadable blocks.

2. The optical disc of claim 1, including a navigational data block, within the program area, comprising the first index.

3. The optical disc of claim 2, wherein the navigational data block further comprises the second index.

4. The optical disc of 1, wherein the second index comprises preferred playback pointers.

5. The optical disc of claim 1, further including outside the program area, one or more further copy protection blocks containing unreadable data.

6. The optical disc of claim 5, wherein the further copy protection blocks are at an initial and/or final position on the optical disc.

7. The optical disc of claim 5, wherein the one or more further copy protection blocks include authentication information.

8. The optical disc of claim 7, wherein the authentication information is contained within the unreadable data.

9. The optical disc of claim 5, wherein the one or more further copy protection blocks include one or more navigational pointers and the first and/or second index indicates said positions indirectly via the one or more navigational pointers.

10. The optical disc of claim 1, wherein the unreadable data is recorded in a data format that is unreadable by an optical disc drive.

11. An optical disc copying program arranged to copy the content data from an optical disc according to claim 1, by accessing the second index and thereby selectively copying the content blocks while avoiding reading the copy protection blocks.

12. An optical disc having content data recorded thereon, in a format comprising:
a. a program area on the disc, comprising content data and a navigational index,
b. outside the program area, one or more copy protection blocks containing unreadable data and one or more navigational pointers,
wherein the navigational index is an indirect index via the one or more navigational pointers.

13. A method of authenticating an optical disc as corresponding to a disc according to claim 7, comprising determining whether the one or more further copy protection blocks contain said authentication information.

14. A method of authenticating an optical disc as corresponding to a disc according to claim 1, comprising:
a. determining from a database whether an original disc containing said one or more content blocks should include one or more of said copy protection blocks, and if so;
b. determining the disc as authentic if said copy protection blocks are present.

15. A method of manufacturing an optical disc, comprising formatting content data in a format comprising:
a. a plurality of program blocks within a program area on the disc, the program blocks comprising one or more content blocks comprising the content data, and one or more copy protection blocks containing unreadable data,
b. a first index indicating the positions of each of the plurality of program blocks; and
c. a second index indicating the positions of the content blocks without indicating the positions of the unreadable blocks.

16. A computer program including program code arranged to perform the method of claim 13.

17. A database of optical discs, said optical discs being as claimed in claim 7, the database identifying the correct authentication information for each of said discs.

18. A database of optical discs, said optical discs being as claimed in claim 1, the database identifying said discs according to said content data.
